(19) United States
(12) Patent Application Publication
(10) Pub. No.: US 2008/0144549 A1
(43) Pub. Date: Jun. 19, 2008

(54) Wireless Proximity-Based Information System

(76) Inventor: Todd Marques, Pleasanton, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 11/611,077

(22) Filed: Dec. 14, 2006

(51) Int. Cl. H04B 7/00

(52) U.S. Cl. 370/310

(57) ABSTRACT

A Wireless Proximity-Based Information System that enables users to gather and store information about objects in their immediate surroundings. The system consists of three components: (i) an Information Server, (ii) a User Interface Client, and (iii) an Administrative Toolkit. The Information Server is packaged as a self-contained, headless electronic device that can be embedded in, attached to, or placed nearby the object it describes. The User Interface Client resides on a mobile phone, PDA, or other handheld device. It provides the means to communicate real time over-the-air with all Information Servers within range. The Administrative Toolkit is a desktop application for controlling the Information Server. It provides capabilities to (i) create, revise, and download information content, (ii) regulate access to content, (iii) upload and analyze usage and performance statistics, and (iv) manage the distribution of Information Server patches and upgrades.

### I. BACKGROUND OF THE INVENTION

A. Field of the Invention

This invention relates to a system that transmits an information profile about an object wirelessly from a fixed server-broadcast device to a mobile client-receiver device based on the mobile device's proximity to the profiled object.

B. Description of Related Art

The present invention serves the need for a system that provides immediate information at the most helpful time when a user is in the immediate area of an object being viewed. The system provides information about a selected object conveniently, unobtrusively, and in real time.

Due to the importance of immediacy and context in communication effectiveness, proximity-based systems have been developed in various forms. Public information or help desks are examples of traditional proximity-based information systems.

Modern technology has been used to significantly vary and improve on the availability and usefulness of proximity-based information.

Shteyn, U.S. Pat. No. 6,782,253, describes a system that alerts users to the availability of proximity-specific data by way of a beacon. The beacon signals the user's mobile phone with a message that conveys sufficient detail about the information to determine (i) whether the user desires the information (via previously set filters) and (ii) the server location where the actual content is available. This Mobile Micro Portal is configurable and allows users to create profiles to specify the types of services of interest.

Compared to the present invention, the Shteyn system has a different physical architecture of the system and system administration. The beacon is part of the difference in architectures. The present invention eliminates the need for a separate beacon because in the present invention the broadcast server device serves both the function of a beacon and a content provider. This eliminates the need for mapping between beacon signal and data source, making the present server-broadcasting device self-contained. Also with the current invention there is no external network required for the transmission of beacon signals and information content. Neither the cellular phone network nor the internet is used.

Another distinction between the Shteyn system and the present invention involves push or server-initiated technology. Shteyn is based push technology and argues that push technology (and the attendant profiles and filters) constitute improved usability over client-initiated or pull technology. However, the present invention is based on client-initiated or pull technology, which actually works best in a proximity-based information system. To avoid the inevitable spam and bombardment of marginally relevant content there must be elaborate filtering—this is not a nicety but a necessity. Push technology on a mobile phone or PDA can in some respects have all the appeal of a telemarketing cold-call at mealtime. Furthermore, push technology brings added complexity, from the user experience and software design perspectives. Pull technology is simpler to implement, yielding simpler User Interface Client designs and improved user experience and cleaner, more reliable software. More importantly, pull technology is actually a better, more intuitive fit for the task demands of a proximity-based system. It is akin to browsing in a store and periodically hearing “May I help you?” or “Have you seen this?” (push) from sales staff, verses asking for assistance when needed (pull). The latter pull model is almost certainly more efficient, provided there is sales staff immediately standing by.

Hale, U.S. Pat. No. 6,785,539, describes a wireless system that uses positional cues to activate context-sensitive multimedia content on a portable device. The content can be delivered in multiple languages and is configurable in other ways to suit individual preferences. Like Shteyn, Hale uses a separate transmitter to identify and communicate location and/or context information that is utilized by software running on the portable receiving device carried by the user. In contrast to Hale, the present invention does not have a separate mechanism for signaling context. In the present invention, context is always implicit through the close physical proximity between the broadcasting server and the object that is being described. The broadcasting server is visually identifiable (e.g., through a flashing LED) and users actively interrogate it to determine its contents and then selectively retrieve the information of interest. Once again, this is pull technology.

Another distinction between Hale and the current invention centers on the storage of content. Hale stores content on the portable device and relevant portions are triggered by context information communicated by the wireless transmitters. In contrast, in the present invention, all information initially resides on the broadcasting server.

GPS technology has the potential to play a significant role within various proximity-based information system implementations. The basic idea is to use GPS to fix a location, which is tantamount to establishing context, and use that context as an index into other centralized databases or internet sites. The current invention is different from any GPS-based approach because since there is no indirection, there is no lookup based on location that serves as a precursor to some other action (e.g., information retrieval). The information-broadcasting server is self-contained and pre-positioned within the physical context in which it is to be used.

Gellersen (Gellersen, Hans, Smart Its: Computers or Artifacts in the Physical World, March 2005, Vol. 48 Communications of the ACM, No. 3) has developed subminiature devices that are embedded within or attached to everyday objects such as tables, chairs, and storage containers. These devices are self-contained and can communicate with one another. They can be programmed to process and report various types of sensor data associated with the objects to which they are attached. These devices have a tiny form factor and favor placement in building materials, roadways, and other areas where sensor data is required. However, they lack the performance, capacity, open software architecture, and administrative capabilities of the present invention, all of which are required to function within a completely generic wireless proximity-based information system that can support any type of device without recompilation.

### II. SUMMARY OF THE INVENTION

The goal of this Wireless Proximity-Based Information System is to provide people with relevant information where and when they want it. The present invention is a general-purpose system for providing on-the-spot information about objects of any type to users who are within the immediate proximity of that object.

Applications include, but are not limited to:
Automotive—brief model-specific product guide and reference for rental car companies, dealerships, and for car owners;
Conferences & Events—professional and personal data on conference attendees, also relevant to numerous other fun, purely social occasions such as club events, mixers, parties, etc;
Information Center—directories and general information about large public venues, including mass transit stations, stadiums and arenas, hospitals, zoos, shopping malls, and theme parks;
Museums—details about museum exhibitions and individual exhibits;
Parks & Traits—Use in state parks, arboretums, and other recreational settings, site maps, specifics about surrounding plant life, indigenous animals, and prominent natural features;
Restaurants—communication to passers-by details about its history, menu, recent reviews, staff bios, and hours of operations; equally applicable to other types of storefronts such as jewelry stores, art galleries, and department stores;
Retail—in-store product-specific displays containing product features, specifications, technology description, user guides, manuals, competitive analysis, or pricing;
Cemeteries—information available graveside, from mausoleurm crypts, and from cremation urns about the decedent, including biographical details, photos, sound clips; also appropriate in locket form to remember significant others or special occasions;
Sports—from the bleachers or sidelines spectators could access team rosters, game schedules, standings, rules of the game, or information about sponsors.

### III. DESCRIPTION OF THE DRAWINGS

FIG. 1 shows the principal components of the wireless proximity-based information system of the present invention.

FIG. 2 shows a high-level view of the information broadcast server device.

FIG. 3 shows a high-level view of the information receiver client device.

FIG. 4 shows an information receiver client device of the present invention discovering various broadcast server devices, also part of the present invention.

FIG. 5 shows the many-to-many communication capabilities among various broadcast servers and receiver clients.

FIG. 6 shows a generic presentation model for the wireless proximity-based information system of the present invention.

### IV. DETAILED DESCRIPTION OF THE INVENTION

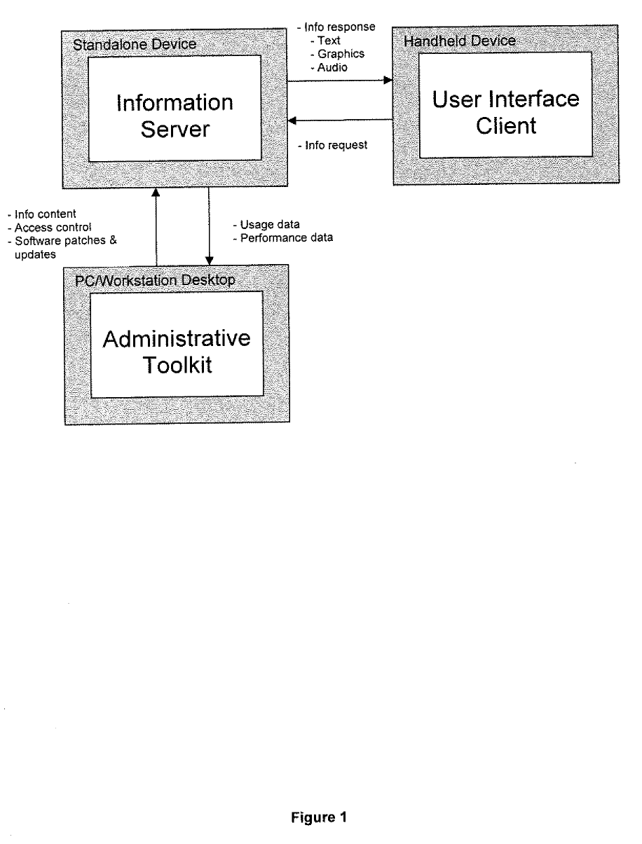

The system consists of three principal components: an Information Server, a User Client, and an Administrative Toolkit, referred to collectively as the system throughout this discussion. A high-level view of the system is given in FIG. 1.

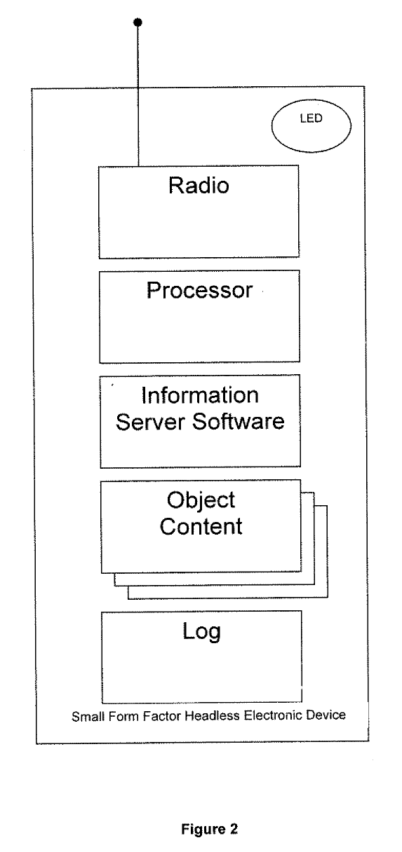

The Information Server is a small, headless electronic device that as depicted in FIG. 2 includes a processor, radio such as Bluetooth Class 2 (10 m range), LED, agent application software, and object-specific content consisting of source material (text, graphics, audio) and content access permissions. A single Information Server may support multiple objects. For instance, one Information Server in a shopping mall may support 8 different store objects. The Information Server is a passive device that listens for and responds to information requests from remote User Interface Clients and to Bluetooth SDP messages.

Information Server instances differ from one another in only two respects: (i) the object-specific content, and (ii) form factor, which is discussed later. The Information Server software and all other components are object-independent. Consequently, no software components need to be recompiled to support a new object.

All content delivered by Information Server is encoded using a human readable, object-independent Content Definition Language (CDL). This is made up of statements consisting of dot-prefixed commands and pipe-separated arguments.

CDL statements specify:
Topics and associated descriptive text;
Basic formatting instructions to, for instance, insert line breaks, create paragraphs, etc.;
Image files that should be embedded in the text content;
Sound files that should accompany the text and images, and whether the designated files should be played once or in looping mode.

CDL source is interpreted in real time by the User Interface Client.

The Information Server logs all transaction details so that system activity and performance can be analyzed offline via Administrative Toolkit, which will be discussed later. The log includes the date and time at which each query was received, the physical address of the device that issued the query, and the specific information that was requested in each query. Similar data is logged for each response.

Information Server can be attached to the object it supports, embedded within the object, or placed nearby. Various device enclosure sizes, shapes, and attachment mechanisms are envisioned to support a range of consumer preferences and applications. Information Server form factors include but are not limited to stick-on casing with adhesive backing or screw mount, ruggedized weatherproof casing for outdoor or demanding environments, key chain fob, and wearable form factors such as lanyard, pendant, locket, necklace, bracelet, earring, or brooch.

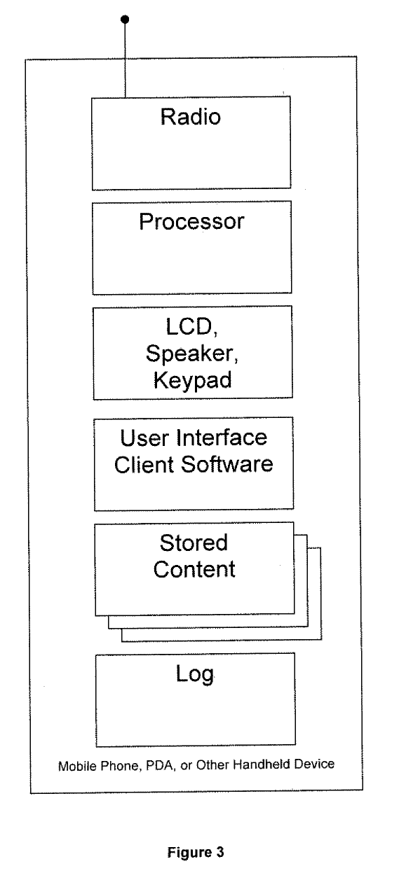

The User Interface Client, which is represented at high level in FIG. 3, provides the means to discover available Information Server-enabled objects, query the Information Servers, and display Information Server responses to the user. It resides on a mobile phone, PDA, or other handheld devices equipped with a Bluetooth radio, LCD, speaker, keypad, and the requisite processor power and memory.

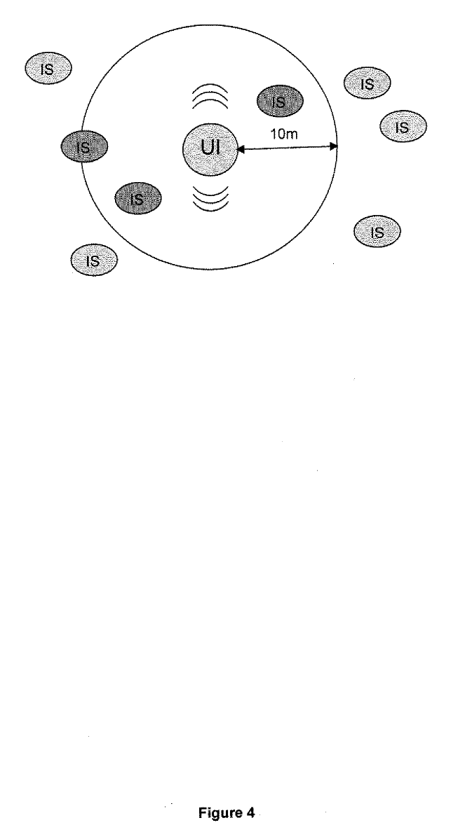

User Interface Client has two basic modes of operation: (i) real time proximity-based operation, which involves live interaction between the User Interface Client and one or more Information Servers and (ii) offline operation, which allows users to store content obtained from real time operation for subsequent use, and frees them from time and proximity constraints. Real time operation can be summarized as follows:
A user identifies one or more interesting objects in close proximity that are equipped with an Information Server—as indicated above, each Information Server will have a flashing blue LED to make itself instantly recognizable.
User Interface Client is invoked on the user's mobile phone, PDA, or other handheld device.
At startup the User Interface Client uses the Bluetooth Service Discovery Protocol to identify all Information Servers within a 10 m radius. The example in FIG. 4 shows three Information Servers within the 10 m radius and hence discoverable.
Once an Information Server is discovered, a query is transmitted to determine the ID of supported object, the alphanumeric display strings to be associated with the object, and the icon that is intended to symbolize each object and will be shown along side the display string in the User Interface Client. Note: an Information Server may support multiple objects, in which case, multiple object IDs, icons, and display names will be retrieved and displayed.
The object screen is then created by the User Interface Client running on the user's mobile phone, showing as a selectable list all available objects (their icons and display strings).
When an item is selected by the user from the list, the User Interface Client sends a message to the designated Information Server requesting a list of topics associated with the selected object.
When a topic is selected through the User Interface Client another message requesting the information is send to the Information Server.

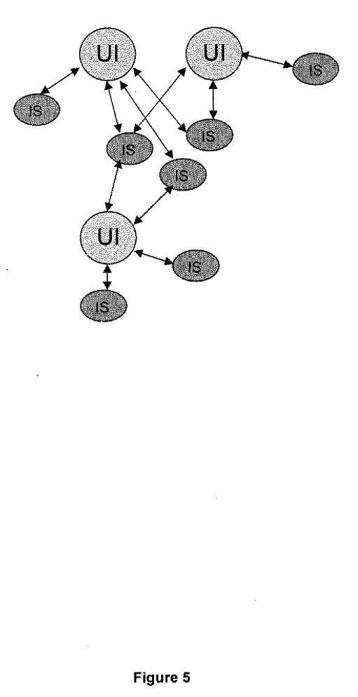

As shown in FIG. 5, many-to-many communication is supported between Information Servers and User Interface Clients. One User Interface Client may access multiple Information Servers, each of which can provide service to multiple User Interface Clients.

Consider the following scenario, which will be used to illustrate real time operation as described above, and then to show how offline operation could be used.

A business traveler is strolling down an unfamiliar street in an unfamiliar city in search of a good restaurant for dinner. Passing the first of several restaurants the traveler spots a small device with a blinking blue LED affixed to the inside of the front window. Recognizing the device as an Information Server, the traveler reaches for his Bluetooth-enabled mobile phone and invokes the User Interface Client application, which has been pre-installed. The User Interface Client automatically begins searching for nearby Information Servers and quickly discovers, among others, the Information Server in front of the restaurant where the traveler is currently standing. He then clicks on the icon representing the restaurant and has access to details about the menu, prices, hours of operation, recent reviews, and several bios on the restaurant staff. This is real time operation.

The traveler is unsure about what other restaurants may be farther down the street so he saves (via the Save menu option in the User Interface Client) the content that he just received from the current Information Server on his mobile phone and continues his stroll. Several blocks down the street he comes upon another interesting restaurant equipped with an Information Server and repeats the process of viewing the available information. Should he choose the earlier restaurant or the latest one in front of which he is currently standing? To resolve the question—and to refresh his memory—he retrieves (via the Retrieve menu option in the User Interface Client) the data pertaining to the earlier restaurant and then compares the two restaurants. This is offline operation.

The User Interface Client (as with the Information Server) does not need to be re-compiled in order to support object types that it has never before encountered. It avoids re-compilation because: (i) as indicated above, all content it receives from the Information Server is encoded in CDL, which it knows to interpret in real time, and (ii) it uses generic information and presentation models to handle all object types.

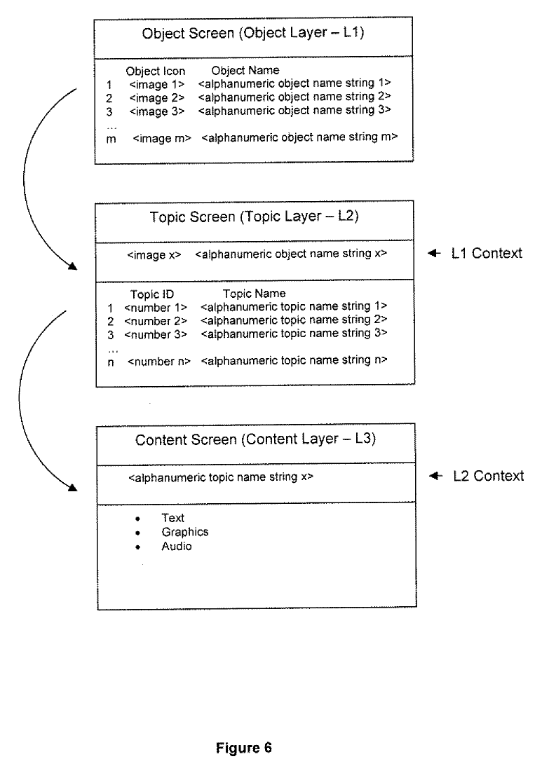

The generic information model consists of a three-level hierarchy:
Object Layer—L1: object (e.g., restaurant, tree, amusement park),
Topic Layer—L2: topics associated with a specific object (e.g., restaurant history, reviews, staff bios, lunch menu, dinner menu), and
Content Layer—L3: associated with given object and topic, encoded in CDL.
The generic presentation model, which is shown in FIG. 6, provides a standard view of the information model described above.

There is a three-screen hierarchy, one screen for each level in the information model:
Object Screen—L1: contains list of objects for which information is available. Each list entry consists of two columns: the first column contains an icon that symbolizes the object in some way (e.g., a dinner fork) and the second column is an alphanumeric string that identifies the object (e.g., JP's Seafood Grotto).
Topic Screen—L2: lists all topics that are available for the designated L1 object. The L2 display consists of two horizontally arranged panels. The upper panel contains the object icon and alphanumeric object name string associated with the L1 selection. The purpose of the upper panel is to provide context for data contained in the lower panel. The lower panel contains a numbered list of topic choices available for the current L1 selection (e.g., 1 restaurant history, 2 reviews, 3 staff bios, 4 lunch menu, 5 dinner menu).
Content Screen—L3: consists of two horizontally arranged panels. The upper panel contains the alphanumeric topic name string associated with the L2 selection. The purpose of the upper panel is to provide the context for data contained in the lower panel. The lower panel displays the text and graphics returned from the Information Server in response to the L2 query. Audio content that is embedded within the text is also played at this time.

User Interface Client also logs all transaction details. The log includes the date and time each query was transmitted, the physical address of the Information Server to which the query was directed, and the specific information that was requested in each query. Response data from Information Server is also logged.

Using this simple presentation model, it is possible to reach any contents associated with any object in two clicks, or two selections. Starting from L1, the User Interface Client top level, the user need only make an L2 selection (click 1) followed by an L3 selection (click 2).

Administrative Toolkit is envisioned as a desktop application to create object-specific content, to download the content to a designated Information Server, and to upload and analyze logs collected on the Information Server. The Administrative Toolkit can also be used to set access permissions for an application. Access permissions determine which devices can and cannot access content associated with a given object.

Administrative Toolkit is also a vehicle for managing Information Server software patches (bug fixes) and updates. Management entails software version control, storage, and the capability to download and install specified software images on designated Information Server's.

1. A generic broadcast server device for a wireless proximity-based information system comprising:
a. A self-contained electronic device containing programmable software that can be configured to broadcast multimedia content describing objects of all types;
b. Wherein the information is broadcast to mobile receiver client devices;
c. Wherein the broadcast device passively listens for and responds to client requests;
d. Communication between broadcast servers and mobile receiver clients is achieved through wireless technology;
e. A generic three-layer information model is used to encode proximity-based information for all object types, the information model comprising:
(1) Layer 1 are objects;
(2) Layer 2 are topics associated with a specific object;
(3) Layer 3 is content associated with a given object and topic.

2. The broadcast server as in claim 1, further comprising a configuration supporting many objects simultaneously.

3. The broadcast server as in claim 1, further comprising the broadcast server device attached to the object it describes.

4. The broadcast server as in claim 1, further comprising the broadcast server being embedded in the object it describes.

5. The broadcast server of claim 1, further comprising placing the broadcast server nearby the object or objects it describes.

6. The broadcast server of claim 1, further comprising all information content in Layer 3 delivered by the broadcast server defined and encoded using a human readable, object-independent content definition language allowing the transmission of content to the receiver client on-demand to be interpreted in real time in an object independent manner.

7. The broadcast server of claim 1, further comprising a standalone desktop-resident authoring tool for producing content in content definition language format that can be downloaded directly to the broadcast server device.

8. The broadcast server of claim 1, wherein the broadcast server includes adhesive backing or screw mount on the hardware enclosure.

9. The broadcast server of claim 8, wherein the broadcast server is ruggedized for outdoor or demanding environments.

10. The broadcast server of claim 1, wherein the broadcast server is in the form of a fob so that it can be worn on a keychain or lanyard, or as a pendant, locket, necklace, bracelet, earring, brooch or in any other way jewelry is worn on the body or clothing.

11. The broadcast server of claim 1, wherein the broadcast server software does not need to be recompiled when the information content is updated, even when it is re-purposed to support an entirely different type of object.

12. A generic receiver client for a proximity-based information system comprising:
a. A generic User Interface Client comprising a generic information model and a generic presentation model encoding and communicating proximity-based information for all types of objects;
b. The generic presentation model follows the generic information model;
c. Communication of proximity-based information for all types of objects, comprising:
(1) A top level Layer 1 object display screen containing a list of selectable objects;
(2) A Layer 2 topics display screen containing a list of selectable topics associated with the current object selection, and an L3 content display screen that may contain text, graphics, and audio corresponding to the current object-topic (L1→L2) selection.

13. The receiver client of claim 12, further comprising:
a. an object-level display comprised of a list of objects for which information is available;
b. Each list entry consists of two columns: the first column contains an icon that symbolizes the object and the second column is an alphanumeric string that identifies the object;
c. The Layer 2 topic-level display lists all topics that are available for the designated Layer 1 object;
(1) The Layer 2 display consists of two horizontally arranged panels, comprising:
(a) The upper panel containing the object icon and alphanumeric object name string associated with the Layer 1 selection, providing context for data contained in the lower panel;
(b) The lower panel containing a numbered list of topic choices available for the current Layer 1 selection.
(2) The Layer 3 display consists of two horizontally arranged panels.
(a) The upper panel contains the alphanumeric topic name string associated with the Layer 2 selection, providing the context for data contained in the lower panel.
(b) The lower panel displays the text, graphics, and audio data returned from the proximity-based information system in response to the Layer 2 query.

14. The receiver client of claim 12, The client software does not need to be recompiled when it encounters an object for the first time because all information necessary to interact with the object is obtainable by issuing a single predefined query to the broadcast server.

15. A generic wireless proximity-based information system, comprising:
a. a small form-factor programmable information server, comprising hardware and software, that is embedded in, attached to, or placed nearby the object it describes;
b. a receiver client, residing on a mobile phone, PDA, or other handheld device that is responsible for transmitting user-initiated information queries to the broadcast server via a wireless transport mechanism and presenting multimedia response content, both in real time and subsequently via a content local storage and retrieval mechanism, in accordance with an object-independent generic presentation model;
c. a desktop-resident administrative toolkit for creating and modifying information content, regulating content access permissions, displaying and analyzing broadcast server usage and performance data, and managing broadcast server software patches and updates.
d. The system built upon an open architecture where all principal system components are designed to be object-independent by relying on generic information and presentation models, a predefined command set, and a shared language for representing content, thereby avoiding recompilation or reconfiguration of any kind to support objects never before encountered.

16. A multipurpose wireless, proximity-based information system comprising:
a. A generic broadcast server device for a wireless proximity-based information system comprising:
(1) A self-contained electronic device containing programmable software that can be configured to broadcast multimedia content describing objects of all types;
(2) Wherein the information is broadcast to mobile receiver client devices;
(3) Wherein the broadcast device passively listens for and responds to client requests;
(4) Communication between broadcast servers and mobile receiver clients is achieved through wireless technology;
(5) A generic three-layer information model is used to encode proximity-based information for all object types, the information model comprising:
(a) Layer 1 are objects;
(b) Layer 2 are topics associated with a specific object;
(c) Layer 3 is content associated with a given object and topic.
b. A generic receiver client for a proximity-based information system comprising:
(1) A generic User Interface Client comprising a generic information model and a generic presentation model encoding and communicating proximity-based information for all types of objects;
(2) The generic presentation model follows the generic information model;
(3) Communication of proximity-based information for all types of objects, comprising:
(a) A top level Layer 1 object display screen containing a list of selectable objects;
(b) A Layer 2 topics display screen containing a list of selectable topics associated with the current object selection, and an L3 content display screen that may contain text, graphics, and audio corresponding to the current object-topic (L1→L2) selection.

17. The multipurpose wireless, proximity-based information system as in claim 16, farther comprising:
a. A computer-resident software toolkit for creating and modifying information content, regulating content access permissions, displaying and analyzing system usage and performance data, and managing system software patches and updates.
